(19) United States
(12) Patent Application Publication
(10) Pub. No.: US 2009/0026096 A1
(43) Pub. Date: Jan. 29, 2009

(54) Disc protector

(76) Inventor: Roger Lawcock, Burlington (CA)

Correspondence Address: Roger Lawcock, 204 Penn Drive, Burlington, ON, L7N2B7, CA

(21) Appl. No.: 11/878,327

(22) Filed: Jul. 24, 2007

(51) Int. Cl. G11B 33/04

(52) U.S. Cl. 206/308.1

(57) ABSTRACT

A disc protector is described for use in the field of optical data storage discs where commonly known applications are compact discs (CD), digital versatile discs (DVD) and super audio compact discs (SACD). In particular a method to improve disc-holders is described where a protective material is present between the data-access surface of the disc and the disc-holder.

### REFERENCES CITED

U.S. Pat. No. 4,736,840. Apr. 12, 1988, Deiglmeier.
U.S. Pat. No. 4,850,731. Jul. 25, 1989, Youngs.
U.S. Pat. No. 4,879,710. Nov. 7, 1989, Iijima.
U.S. Pat. No. 4,983,437. Jan. 8, 1991, Merrick.
U.S. Pat. No. 5,299,186. Mar. 29, 1994, Tsurushima
U.S. Pat. No. 5,787,069. Jul. 28, 1998, Lowe et al.
U.S. Pat. No. 6,240,061. May 29, 2001, Burroughs.
U.S. Pat. No. 5,848,687. Dec. 15, 1998, Shultz.
U.S. Pat. No. 6,409,014. Jun. 25, 2002, Hummel et al.
U.S. Pat. No. 6,667,953. Dec. 23, 2003, Matson et al.

### WO 2005/070698 A1. Aug. 4, 2005, Ludvigsen.

### EP 1,489,618 A2. Dec. 22, 2004. Kondo.

http://envelopes.tyvek.com/en/applications/styles_disc.shtml
http://www.dupont.com/nonwovens/ap/sontara.html

### FIELD OF THE INVENTION

The invention has application to the protection of optical data storage discs when they are located in conventional disc holders.

### BACKGROUND OF THE INVENTION

The invention relates to the protection of optical data storage discs that are used in a variety of applications. Examples are CD data discs, DVD data discs, DVD video discs, DVD audio discs, CD audio discs and SACD audio discs. The cited examples cannot be considered to be exclusive since new types of discs continually appear as new types of discs are produced, HD-DVD and BD are recent examples, and it is expected that other types of disc will continue to be developed where the herein described protection method will be of value. The broad application range of such discs can be considered by their common uses, examples being; data storage in home, business, industrial and scientific applications; the storage of video and music data in home and personal entertainment applications; the storage of digital photograph data in domestic and professional applications and the storage of data in computerized game systems. In view of the many options available for the use of the data discs, it has to be expected that there will be other types of applications for the described disc protection method. The term disc is used in this document to categorize all optical data storage discs as the subject in the description of the invention.

In regard to the invention described herein, the relative construction features of the discs are an optically transparent outer layer which protects an inner layer of data storage media. A problem with such discs relates to degradation of the transparent surface layer which covers the inner data-containing material. The transparent layer is usually a polycarbonate or equivalently natured material which is transparent to external data-reading devices and is also relatively mechanically soft. In normal use and handling, the transparent layer can become damaged, even small surface flaws, over time, may accumulate and produce an obscured surface texture to the originally highly polished surface. Eventually the surface degradation may reach such a level that the data-reading device can no longer read data that is present on the inner data-containing surface. Such loss of data reading ability can be catastrophic since the preciously recorded data on the disc can no longer be recovered. In the cited, but not inexhaustible examples of use given above, i.e. business, industrial, scientific, home and entertainment applications, loss of use of the disc and its data content is obviously inconvenient. For example, recorded business-data and digital photographs may become un-retrievable, data, music and video files may not be able to be recovered hence rendering the discs unplayable in audio, video and computer game applications. Hence an effective method to protect the surface of the discs is of particular value to ensure longevity of the disc.

The discs are commonly housed in factory-supplied holders known as “jewel-cases” in music and computing CD type applications, and other types of hinged cases in DVD video applications. When out of their storage case, and in use, it is obvious that discs can accumulate damage to the protective layer depending upon how the discs are manually handled or stored before being returned to the storage case.

However, it is less obvious that damage may accumulate to the surface of the disc while they are located within and being transported in conventional storage cases such as CD jewel cases or DVD hinged cases or similar containers. A common drawback of such standard disc-cases is that the data-access surface of the disc may contact against the inner faces of the case such that the surface of the disc becomes scratched. In conventional CD jewel cases, for example, the formed central hub allows rotation and tilt of the disc such that contact can occur between the disc and the case in the data-access areas. Flatness variations in the base of the case can also contribute to contact between the case and the disc. Therefore when a jewel case is moved, the CD contained inside can become damaged due to relative motion and contact between the disc and the case. Repeated scratching of the surface of the disc can lead to the situation where the data that is present can longer be accessed by the reading device. Methods to protect optical data storage discs have previously been issued, however none describe the combined advantages of the method that is disclosed herein.

A method of disc protection using a layered disc approach is shown in U.S. Pat. No. 4,736,840 where the data-disc is located between other protecting discs, the layered assembly is costly and imposes additional practical complexity in disc handling. A protection method is shown in U.S. Pat. No. 4,850,731 by disc storage in flexible and soft envelopes, however the method precludes use of conventional disc holders and therefore disc titles or content cannot be viewed when large numbers of discs are stored in vertical stacks or in horizontal rows. Protection methods suggesting the attachment of transparent material to the disc are described in U.S. Pat. No. 4,879,710, and U.S. Pat. No. 4,983,437; neither increasing the thickness of the disc nor the use of other layers on the disc are preferred since there may be interference with the data reading device. A method of supporting the data-access surface by soft rings of material is shown in U.S. Pat. No. 5,299,186, however the method relates to storage of discs outside of the standard case, hence there is a disadvantage in that the supporting documentation is not carried with the disc, also in storage of a large quantity of discs, the title or content of the disc cannot be viewed. Application of transparent outer shells or layers to the disc has been described for example in U.S. Pat. No. 5,787,069 and U.S. Pat. No. 6,240,061, which increase the thickness of the disc and hence may interfere with the data reading device. A method of raising the outer diameter portion of the disc by application of a flexible band is described in U.S. Pat. No. 5,848,687 the flexible band may not fully protect the data access portion of the disc, and the flexible band may undesirably interfere with the disc reading device. Modification of the disc holder to incorporate a central-hub and raised-ribs is disclosed in U.S. Pat. No. 6,409,014 however the raised rib supports are manufactured form relatively hard material that may damage the disc, also the special shape prevents the use of conventional disc holders. A method of adhesively attaching rings of supportive material to the inner and outer regions of the disc is described in U.S. Pat. No. 6,667,953 however the undesirable increased disc thickness may pose problems with disc reading devices. WO 2005/070698 A1 describes methods of disc storage comprising flexible sheets, however the proposed construction is not usable with conventional disc holders, hence in storage of a quantity of discs the title or content of the disc inconveniently cannot be viewed. A new type of disc storage case is disclosed in EP 1489618 A2 where a central hub release mechanism is shown but there is no description of a disc surface protection feature.

### SUMMARY OF THE INVENTION

Hence it is the objective of the current invention to provide a method of disc protection without the disadvantages of prior disclosures. It is further an objective of the invention to provide a method for the protection of discs while they are stored in conventional disc cases such that documentation can be retained with the disc, and the disc content can be determined by viewing the external spine when large quantities of discs are stored in their cases either in vertical stacks or in horizontal rows. The invention does not require the addition of material to the disc, hence the potential for interference with disc reading devices is avoided.

The objectives are achieved by the provision of a protective insert that separates the disc holder surface from the disc surface. The insert is of the form of a thin annulus and can be placed or affixed into conventional disc holders such that disc protection may be achieved at low cost, with no additional complexity in disc handling and provides the use of conventional disc holders.

### BRIEF DESCRIPTION OF THE DRAWINGS

FIG. 1 shows a general view of a disc holder that is improved according to the invention herein.

FIG. 2 shows a general view of a CD and the disc holder (often referred to as a “jewel case”).

FIG. 3 shows a view of the CD installed in the disc holder.

FIG. 4 shows a section through a disc and a conventional CD disc holder.

FIG. 5 shows a section through a disc and an improved disc holder according to the invention herein.

FIG. 6 shows an alternative construction to FIG. 5.

FIG. 7 shows photographs which illustrate an example of the value of the invention.

### DETAILED DESCRIPTION OF THE INVENTION

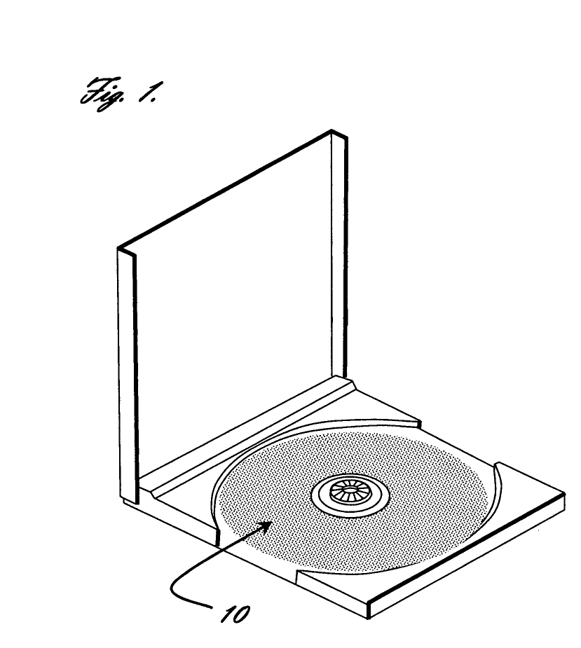

FIG. 1 shows the essence of the new invention where a protective layer 10 is introduced into the base of the disc holder.

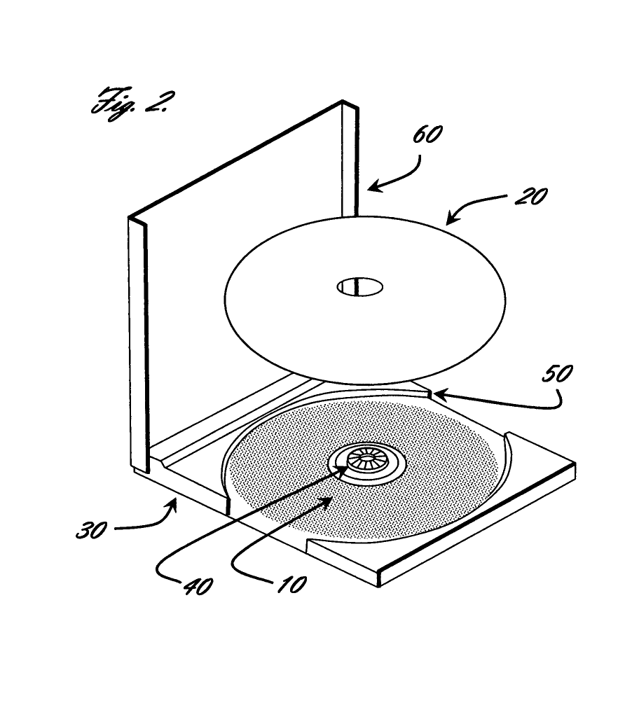

FIG. 2 shows the general arrangement for disc storage cases where the disc 20 installs into the base 30, consisting of an integrally formed central hub 40, and a formed recess 50, the case then be closed with the hinged lid 60.

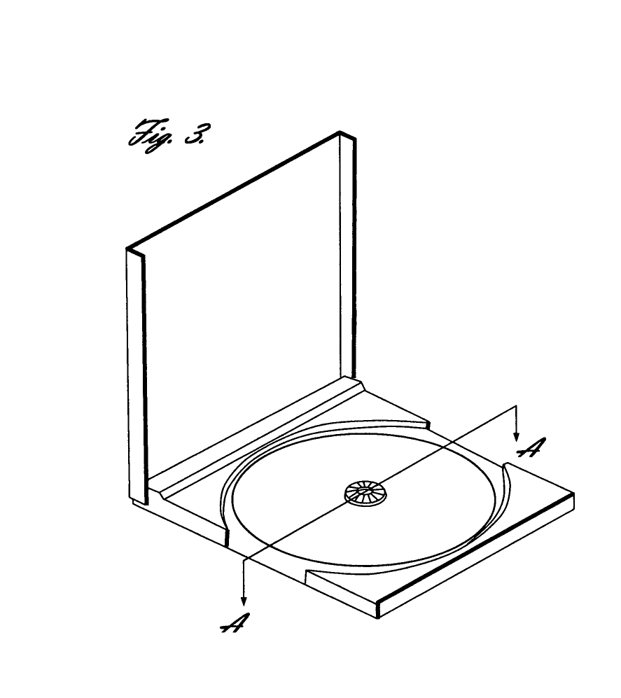

FIG. 3 shows a disc installed in the disc holder, with the hinged lid in the open position, to reveal section A-A which is used to provide further detailed description of the invention.

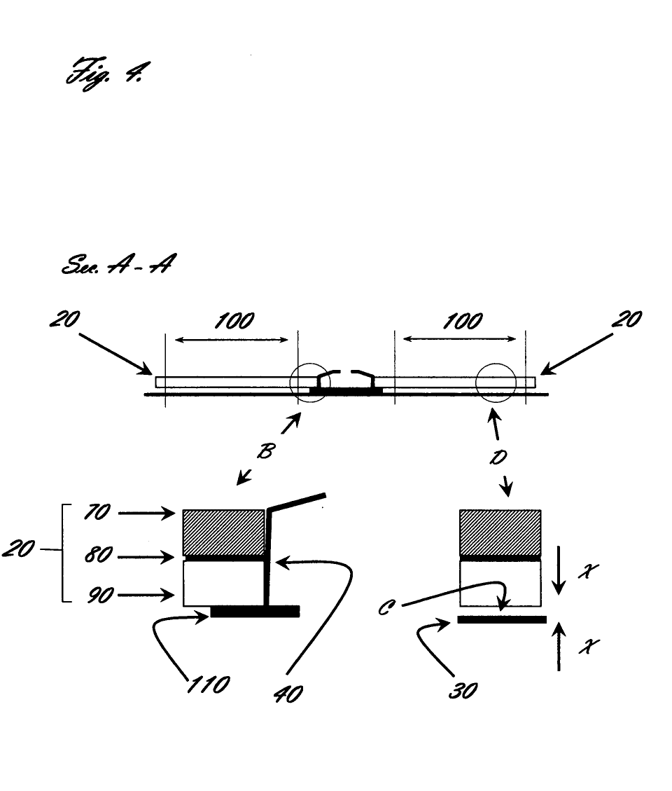

FIG. 4 shows the section at A-A for a disc that is located in conventional disc holder. The disc 20 is shown mounted on the central hub 40 in view B, further the disc 20 is shown to comprise of three layers, a backing layer 70, a central data containing layer 80 and an optically transparent protective layer 90. Typical dimensions of the discs 20 are 120 mm in diameter, a central spindle hole diameter of 15 mm and a thickness of 1.2 mm. The data containing area 100 is between the disc diameters of 50 mm and 116 mm. The central hub of the case rises from a formed raised shoulder 110 of a diameter in the range of 20 mm to 30 mm depending upon the preference of the case manufacturer. The thickness of the raised shoulder is usually around 0.5 mm, thus when the disc is installed in the case a gap of around 0.5 mm is created between the disc surface 90 and the case surface 30 as depicted in FIG. 4, section A-A. The intent of the design is to prevent contact of the transparent and relatively soft disc surface layer 90 with the disc case 30. However it can be envisioned as shown in view D of FIG. 4 that contact may occur as denoted at point C due to relative motion in the direction X-X a result of tilting of the disc and due to motion of the case while being handled or transported, also with possible minor rotation of the disc on the spindle while the case is being handled or transported, together with possible imperfections in flatness of the formed disc base 30.

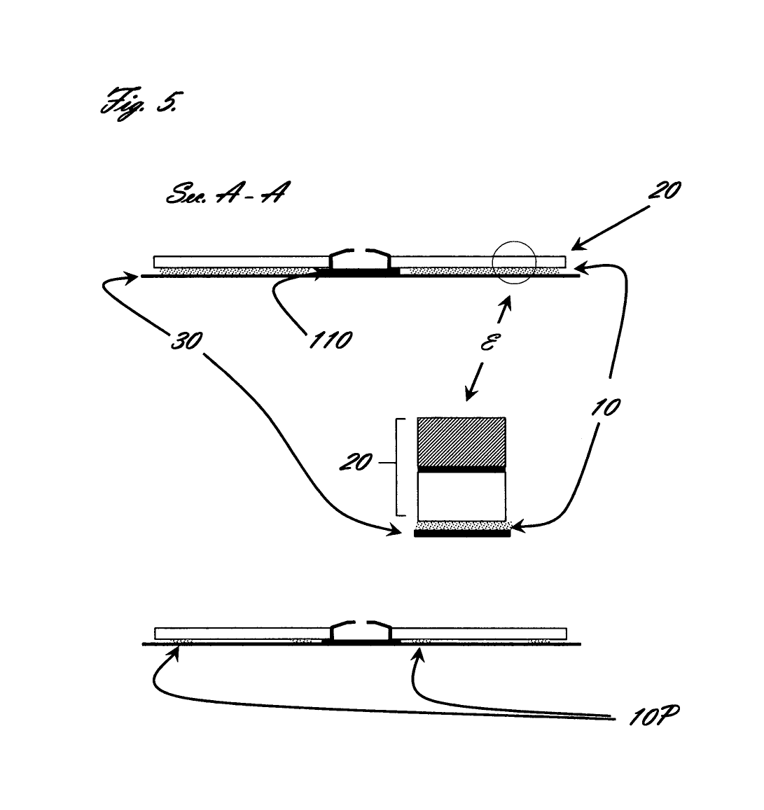

FIG. 5 and the detail of view E illustrate how the invention disclosed herein protects the surface of the disc 20 from contact with the case base 30, by the presence of a protecting material 10. The protecting material preferably has dimensions to fully protect the data containing area that lies within diameters of 50 mm and 116 mm, also the central hole of the protecting material must fit over the formed hub shoulder 110. The thickness of the protecting material does not exceed the thickness of the raised shoulder which is usually around 0.5 mm. Hence the preferred dimensions of the protective material are: an inner diameter of around 40 mm to be greater than the hub shoulder and less than the data-area; an outer diameter of around 120 mm to be greater than the data-area and smaller than the disc case recess 50 of FIG. 1; and a thickness of less than 0.5 mm to be contained within the space provided by the hub shoulder 110 of FIG. 4.

Hence a preferred protector would be an annulus of soft material 120 mm in outer diameter, with a central hole of 40 mm and have a thickness of less than 0.5 mm. Such a protector allows the use of conventional disc holders but eliminates the potential damage that may occur by contact between the disc and the disc holder.

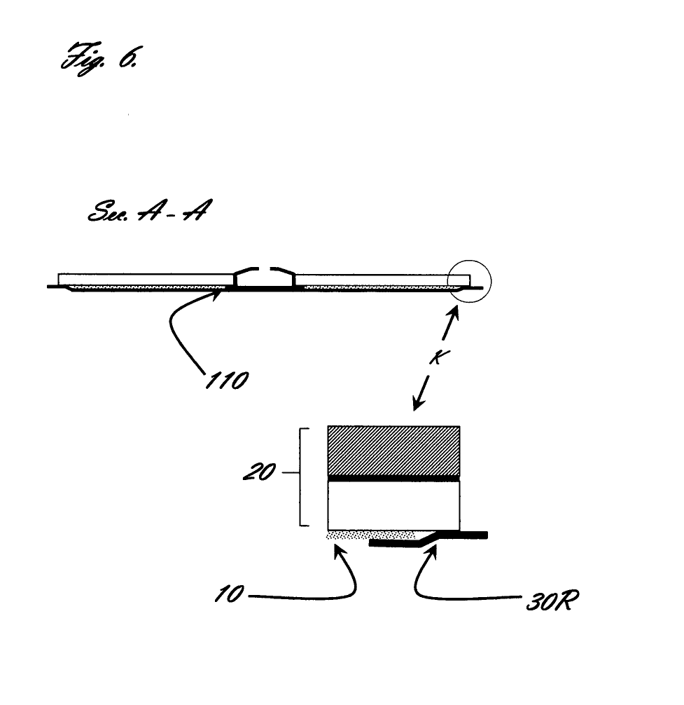

Other methods to the preferred embodiment are shown in FIG. 5 where 10P indicates the placement of two rings of protecting material in the disc holder and FIG. 6 shows a modified case holder with a raised rim 30R in view K. The raised rim offers support of the disc away from the hub and the disc protecting material 10 is contained within the raised rim 30R and the hub shoulder 110.

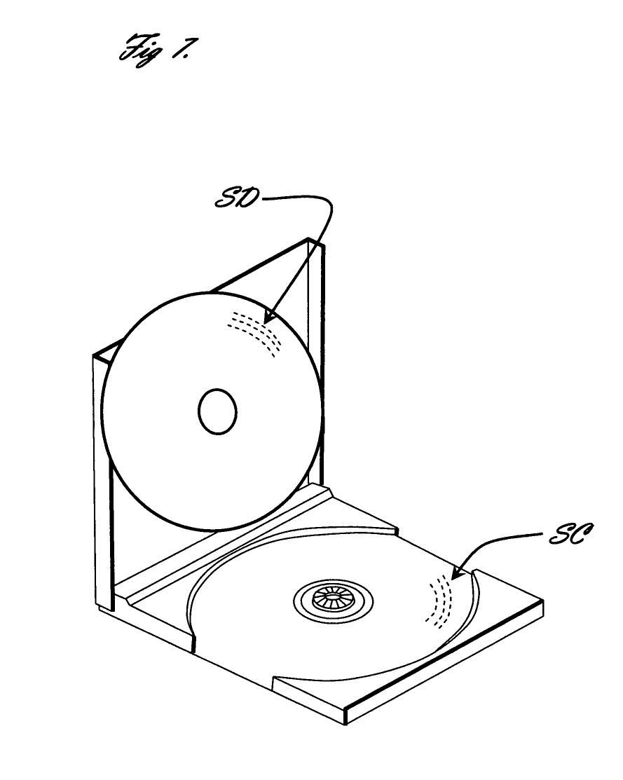

An example of the value and application of the described disc protector is shown in FIG. 7 where the scratched surface of a disc SD is shown to have been caused by contact with the disc holder at SC. The transparent surface of the disc has become damaged while located in the case. The protector that needs to be positioned between the disc and the disc holder can be manufactured from a broad range of fabrics, provided that the material is soft, lint free, non-damaging to the disc and durable. The choice of material for the disc protector needs to be made carefully to provide correct protection to the discs. For example paper tissue may be unsuitable since the contained wood fibers could cause disc scratching, and the tissue is not durable. Lens cleaning microfiber type fabrics could be used, but are quite high in cost. Lower cost alternative materials such as Tyvek® or Sontara® manufactured by the E.I. du Pont de Nemours and Company of Wilmington, Del. may be more suitable. Tyvek® has been reported to offer archival quality protection as CD storage envelopes (http://envelopes.tyvek.com/en/applications/styles_disc.shtml) although the use has not previously been reported for use as a disc case insert. A softer material such as Sontara® (http://www.dupont.com/nonwovens/ap/sontara.html) may be more preferable. The brief discussion of material types is presented to illustrate the nature and the broad range of fabrics that could be used for the protector, the key features are that the material needs to be soft, lint-free, durable and non-abrasive to the disc.

The protector will be functional if placed in the disc holder, however a preferred embodiment of the invention may be to affix the protector in position with an adhesive.

1) An improved method for the storage of optical data discs by the use of a protector that locates in the disc holder, the said protector comprises;
a) a material that is soft, lint free and non-abrasive to the disc.
b) a central hole of around 40 mm, the hole dimension being selected to be sufficient to fit over the central hub shoulder of the disc case and smaller than the inner diameter of the data layer of the disc.
c) an outer diameter of around 120 mm, the outer diameter dimension being selected to be greater than the outer diameter of the data layer of the disc and smaller than the recess of the disc case.
d) a thickness that is less than the shoulder of the hub in the disc case.
e) a thickness that is less than 0.5 mm for use in CD “jewel cases”.
f) a thickness that may be greater than 0.5 mm but less than the shoulder of the hub for use in other disc case designs.
g) an adhesive to affix the insert into the disc case.

2) A method where the disc protector comprises a single ring or a plurality of protective rings of material.

3) A method where the disc protector material is used in a disc holder which has a raised rim in the base at the outer diameter region of the disc.
